(19) United States
(12) Patent Application Publication
(10) Pub. No.: US 2023/0334640 A1
(43) Pub. Date: Oct. 19, 2023

(54) FOOD DISPOSAL TIMING MANAGEMENT DEVICE, FOOD DISPOSAL TIMING MANAGEMENT SYSTEM, AND FOOD DISPOSAL TIMING MANAGEMENT METHOD

(71) Applicant: J-OIL MILLS, Inc., Tokyo (JP)

(72) Inventors: Kenichi KAKIMOTO, Tokyo (JP); Ryohei WATANABE, Tokyo (JP); Ayato TAKASAKI, Tokyo (JP); Masami INOUE, Tokyo (JP)

(21) Appl. No.: 18/016,705

(22) PCT Filed: Jul. 15, 2021
(86) PCT No.: PCT/JP2021/026553

§ 371 Date: Jan. 18, 2023

(30) Foreign Application Priority Data
Jul. 30, 2020 (JP) 2020-129435

(51) Int. Cl. G06T 7/00; G06T 7/90; G06V 10/56; G06V 20/68

(52) U.S. Cl. CPC G06T 7/0002; G06T 7/90; G06V 10/56; G06V 20/68; G06T 2207/20081; G06T 2207/10024; G06V 2201/06

(57) ABSTRACT

Provided is a food disposal time management device capable of managing a disposal time of a plurality of cooked foods being displayed in a display cabinet individually and easily. A fried food disposal time management device 4 for managing a disposal time of fried food X displayed in a hot showcase 1, comprising: an image acquisition unit 41 that acquires an image including images of a plurality of pieces of fried food X being displayed; an individual surface image management unit 42 that manages a surface image included in the image in association with identification information; a time measurement unit 43 that measures a time during which the surface image associated with the identification information is being included in the image; and a determination unit 45 that determines, for each of the plurality of pieces of fried food X, whether the measured time thereof has reached a reference time.

### TECHNICAL FIELD

The present invention relates to a food disposal time management device, a food disposal time management system, and a food disposal time management method, which manage the time to dispose a prepared food (hereinafter, referred to “cooked food”) displayed in a display cabinet.

### BACKGROUND ART

In recent years, stores such as convenience stores and supermarkets display cooked foods such as prepared meals in a display cabinet and sell them (for example, offer the deep-fried foods cooked using fryers equipped in the stores to customers). Such fried foods are displayed, for example, in hot showcases (also referred to as hot food display cases, food warmer, warming cabinets, or the like) which are display cabinets having keep warm function. The hot showcases have functions to manage the conditions in display spaces in order to allow the cooked foods to be displayed therein while maintaining conditions thereof suitable for sale. Patent Literature 1 discloses an in-compartment temperature setting device for a showcase that can set or change the in-compartment temperature of the hot showcase to the temperature suitable for foods displayed therein based on information such as a temperature range for preserving the displayed food and an optimum temperature range for offering it to customers.

There have been various management indicators for maintaining the quality of cooked foods displayed in a display cabinet including a hot showcase. Especially in the case of fried foods, among these management indicators, an indicator of “elapsed time after finishing of deep-frying” has been known as a management indicator that can be easily measured. It is commonly known that the flavor of fried foods decreases over time.

Based on the technique disclosed in Patent Literature 1, even if the temperature in the hot showcase is controlled to be a temperature suitable for fried foods, it is often the cases that the fried foods which kept displayed in the hot showcase for a long time become unsuitable for sale due to loss of flavor. In view of the above, it is demanded to determine when to stop selling the fried foods displayed in a hot showcase based on the elapsed time.

In order to appropriately manage when to stop selling the fried foods after the finishing of deep-frying thereof, in other words, the time to dispose the fried foods, an employee of a store has to record the time of finishing of deep-frying, measure the elapsed time from the recorded time, and determine whether the measured elapsed time exceeds a reference time in a timely manner so as not to miss the time to dispose.

### CITATION LIST

### Patent Literature

Patent Literature 1: JP-A-2005-83602

### SUMMARY OF INVENTION

### Technical Problem

However, in most cases, a plurality of fried foods is displayed in the display cabinet, and moreover, each of the fried foods is not always in the same position as the position where it was placed immediately after the finishing of deep-frying thereof. This forces an employee of the store to keep recording in detail, for every fried food, not only the time at which deep-frying thereof is finished but also the position on it was firstly placed and the position to which it has been moved, otherwise, the time to dispose the fried foods cannot be accurately determined based on the elapsed time after the time of finishing of deep-frying. Thus, managing the time to dispose fried foods based on the manual operation by an employee of a store causes a problem, in particular, in view of placing a heavy burden on an employee of a store.

Therefore, an object of the present invention is to provide a food disposal time management device, a food disposal time management system, and a food disposal time management method, which are capable of managing the time to dispose a plurality of cooked foods being displayed in a display cabinet individually and easily.

### Solution to Problem

In order to achieve the object described above, the present invention provides A food disposal time management device for managing a disposal time of a cooked food displayed in a display cabinet, comprising: an image acquisition unit that acquires an image including images of a plurality of foods being displayed in the display cabinet; an individual surface image management unit that generates identification information individually identifying a surface image of each of the foods, and manages the surface image included in the image acquired by the image acquisition unit in association with the identification information; a time measurement unit that measures a time during which the surface image associated with the identification information by the individual surface image management unit is being included in the image; a determination unit that determines, for each of the plurality of foods, whether the time measured by the time measurement unit has reached a reference time predetermined as a reference of an elapsed time used in food disposal; and a notification unit that outputs, to a notification device, a notification signal for notifying that a food whose time as measured is determined to have reached the reference time by the determination unit needs to be disposed.

### Advantageous Effects of Invention

According to the present invention, it is possible to manage the time to dispose a plurality of cooked foods being displayed in a display cabinet individually and easily. The problems, configurations, and advantageous effects other than those described above will be clarified by explanation of the embodiment below.

### BRIEF DESCRIPTION OF DRAWINGS

FIG. 1 is a perspective view illustrating a configuration example of a hot showcase.

FIG. 2 is a plan view of the inside of the hot showcase as viewed from the rear side thereof.

FIG. 3 is a system configuration diagram illustrating a configuration example of a fried food disposal time management system.

FIG. 4 is a configuration diagram illustrating a hardware configuration example of a fried food disposal time management device.

FIG. 5 illustrates a graph showing the change in the deteriorated flavor obtained by sensory evaluation with respect to the elapsed time.

FIG. 6 illustrates a graph showing the change in the color density of fried foods obtained by sensory evaluation with respect to the elapsed time.

FIG. 7 illustrates graphs showing the change in color components, which are obtained by capturing still images of a fried chicken being displayed in a hot showcase and analyzing the captured still images, with respect to the elapsed time.

FIG. 8 illustrates graphs showing the change in color components, which are obtained by capturing moving images of a fried chicken being displayed in a hot showcase and analyzing the captured moving images, with respect to the elapsed time.

FIG. 9 illustrates graphs showing the change in color components, which are obtained by capturing still images of a croquette being displayed in a hot showcase and analyzing the captured still images, with respect to the elapsed time.

FIG. 10 illustrates graphs showing the change in color components, which are obtained by capturing moving images of a croquette being displayed in a hot showcase and analyzing the captured moving images, with respect to the elapsed time.

FIG. 11 is a functional block diagram illustrating the functions of the fried food disposal time management device.

FIG. 12 is a flowchart illustrating a flow of processing executed by the fried food disposal time management device.

FIG. 13 is a diagram illustrating a display example of a monitor.

FIG. 14 is a flowchart illustrating a flow of processing executed by a fried food disposal time management device according to a modification of the present invention.

### DESCRIPTION OF EMBODIMENTS

A food disposal time management system according to an embodiment of the present invention is a system for managing the time to dispose cooked foods (including, for example, fried foods such as fried chickens, croquettes, and french fries, steamed foods such as steamed Chinese buns and dumplings, and baked foods such as sausages and grilled chicken skewers) displayed in a display cabinet such as a hot showcase, which is installed near a check-out area in a small-scale store such as a convenience store, or a showcase installed in a prepared meal department (grocery department) in a supermarket and the like. Hereinafter, as an embodiment of the food disposal time management system, a fried food disposal time management system for managing the time to dispose a plurality of fried foods displayed in a hot showcase will be described.

### (Configuration of Hot Showcase 1)

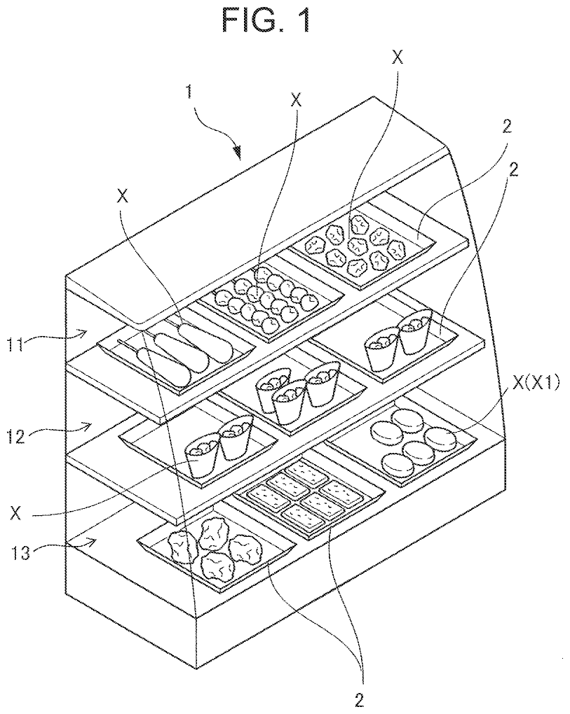

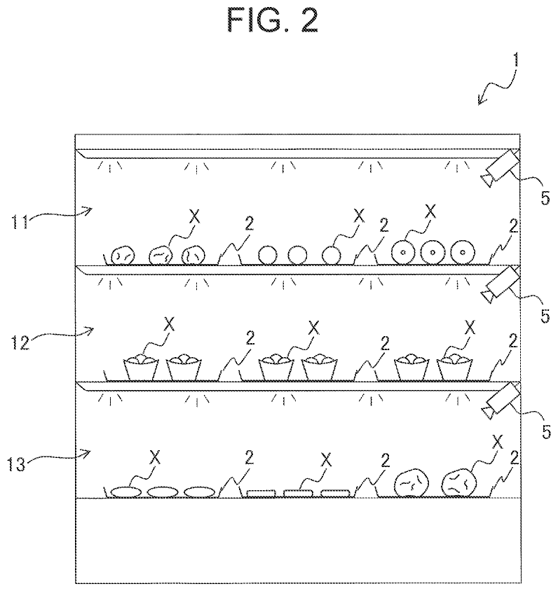

Firstly, a configuration example of a hot showcase 1, which is an aspect of a display cabinet, will be described with reference to FIG. 1 and FIG. 2.

FIG. 1 is a perspective view illustrating a configuration example of the hot showcase 1. FIG. 2 is a plan view of the inside of the hot showcase 1 as viewed from the rear side thereof.

The hot showcase 1 is an example of a display cabinet for fried foods, which is installed in a store such as a convenience store and in which fried foods cooked in the store are displayed. A space inside the hot showcase 1, that is, a display space in which the fried foods are displayed, is kept at a suitable temperature allowing the display environment of the fried foods to be maintained under a suitable condition, and is managed so that the fried foods under preferable conditions can be offered to customers.

FIG. 1 illustrates the hot showcase 1 provided with three floors 11, 12, 13, and a plurality of types of fried food X is displayed on each of the floors 11, 12, 13. The plurality of fried food X is arranged in such a manner that the same type of pieces of fried food X are placed in the same tray 2. In FIG. 1, each of the floors 11, 12, 13 is provided with the three trays 2. In the following, in order to distinguish the floors 11, 12, 13 from each other, the floor on the uppermost stage of the hot showcase 1 is referred to as the first stage floor 11, the floor on the middle stage is referred to as the second stage floor 12, and the floors on the lowermost stage is referred to as the third stage floor 13.

As illustrated in FIG. 2, three cameras 5 serving as image capturing devices for capturing images including images of the plurality of pieces of fried food X being displayed on each of the floors 11, 12, 13 are provided in the hot showcase 1.

In the present embodiment, each of the cameras 5 is arranged on one end side of a top face portion of each of the floors 11, 12, 13, however, the number of cameras 5 and their mounting positions are not particularly limited as long as they can capture images including images of all the plurality of pieces of fried food X being displayed in the hot showcase 1. Depending on the setting of angle of view of each of the cameras 5, there may be a case that the images including images of all the plurality of pieces of fried food X being displayed on the floors 11, 12, 13 cannot be captured. In such a case, providing the plurality of cameras 5 as in the present embodiment enables acquisition of entire images including images of all the plurality of pieces of fried food X and surface images of each of the pieces of fried food X. Furthermore, for example, changing the setting of angle of view of one of the cameras 5 also enables acquisition of entire images including images of all the plurality of pieces of fried food X and surface images of each of the pieces of fried food X.

In the present embodiment, video cameras capable of capturing moving images are used as the cameras 5 so as to acquire the images capturing the movement of each of the pieces of fried food X within the hot showcase 1. Each of the pieces of fried food X being displayed in the hot showcase 1 does not always stay in the same position as the position on which it was placed immediately after the finishing of deep-frying thereof. For example, each of the pieces of fried food X may be moved to a different position within the tray 2 which is the same as that on which it was initially placed, or may be moved to the tray 2 which is different from the one on which it was initially placed.

That is, each of the pieces of fried food X is placed on the tray 2 of any one of the floors 11, 12, 13 in the hot showcase 1 immediately after the finishing of deep-frying thereof, however, the position thereof is not always the same as the time passes. In view of the above, the cameras 5 acquire the motion images capturing the state of each of the floors 11, 12, 13 so as to obtain the entire images capturing the movement (for example, change in the position) of each of the pieces of fried food X included in the moving images. Even when each of the pieces of fried food X placed on the floors 11, 12, 13 is moved, executing the processing by the fried food disposal time management device 4 which will be described later, based on the captured moving images enables identification and tracking of each of the pieces of fried food X and thus acquisition of the condition thereof over time.

Note that the cameras 5 do not necessarily have to be video cameras capable of capturing moving images, but may be the ones capable of capturing images of the fried food X continuously in time. For example, the cameras 5 may be still cameras capable of capturing only still images as long as they can capture the images continuously enough to acquire the movement of each of the pieces of fried food X within the hot showcase 1 as image data.

### (Overall Configuration of Fried Food Disposal Time Management System 3)

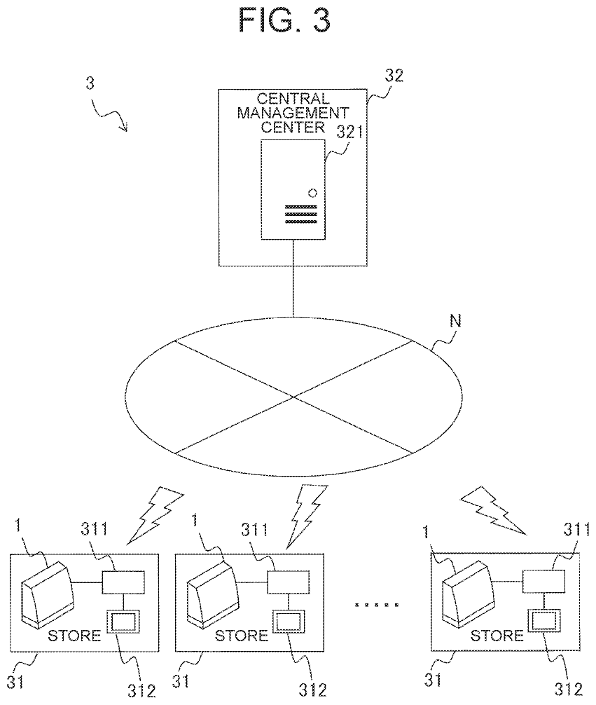

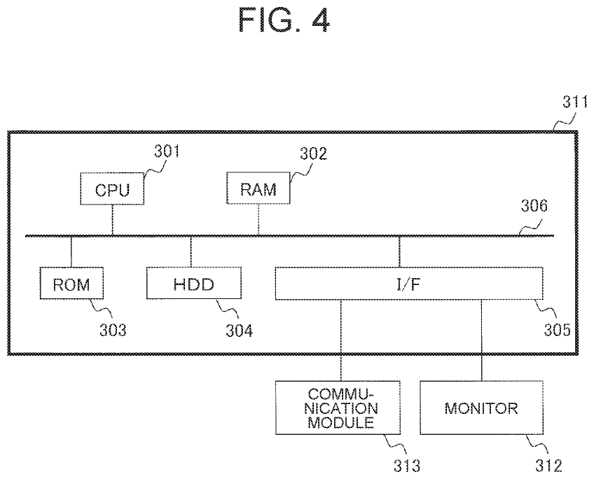

Next, an overall configuration of the fried food disposal time management system 3 will be described with reference to FIG. 3 and FIG. 4.

FIG. 3 is a system configuration diagram illustrating a configuration example of the fried food disposal time management system 3. FIG. 4 is a configuration diagram illustrating a hardware configuration example of a fried food disposal time management device 4.

As illustrated in FIG. 3, the fried food disposal time management system 3 includes controllers 311 installed, respectively, in stores 31 which are, for example, members of a convenience store chain, and a management server 321 installed in a central management center 32 that controls the stores 31. Each of the controllers 311 and the management server 321 are directly or indirectly connected to each other so as to be capable of information communication therebetween via a communication network N such as an Internet communication line.

Each of the controllers 311 is configured to execute the processing such as management of operations (for example, heating) of the hot showcase 1 and management of devices provided in the store 31. The management server 321 is configured to mainly execute processing such as sales management of each of the stores 31.

In FIG. 3, it is assumed that each of the hot showcases 1 is connected to each of the corresponding controllers 311 so as to be able to communicate therebetween. In this case, the means for communication may be wired or wireless. Each of the hot showcases 1 can have a function to, as a function to detect the condition of each of the pieces of fried food X being displayed on each of the floors 11, 12, 13, transmit the detected information indicating the condition of each of the pieces of fried food X to the management server 321. That is, each of the hot showcases 1 may be configured to realize this communication processing without relaying the information to each of the corresponding controller 311 as long as it can transmit at least the detected information related to each of the pieces of fried food X.

Thus, the hot showcases 1 and the controllers 311 mounted thereon do not have to have unique functions. For example, as illustrated in FIG. 4, each of the controllers 311 may include a CPU (Central Processing Unit) 301, a RAM (Random Access Memory) 302, a ROM (Read Only Memory) 303, an HDD (Hard Disk Drive) 304, and an I/F (Interface) 305. It is assumed that these elements are connected to each other via a common bus 306.

The CPU 301 is an arithmetic unit, and controls the entire operations of the controller 311. The RAM 302 is a volatile storage medium capable of reading and writing information at high speed, and is used, for example, as a work area where the CPU 301 executes the image information processing. The ROM 303 is a read-only nonvolatile storage medium, and retains programs such as a firmware.

The HDD 304 is a nonvolatile storage medium capable of reading and writing information and has a large storage capacity. The HDD 304 retains an OS (Operating System), control programs and application programs for executing various kinds of information processing which will be described later, and the like. Note that the HDD 304 may be substituted by a device which realizes functions of storing and managing information as a nonvolatile storage medium regardless of the type of device, and for example, such a device may be an SSD (Solid State Drive).

The I/F 305 is a connection interface with the communication network N, to which a communication module 307 that realizes information communication with other devices such as sensors, a monitor 312 for displaying a user interface, and the like are connected.

Specifically, the monitor 312 visualizes and provides a management status of the hot showcase 1, condition of the fried food X being displayed in the hot showcase 1, and the like, and is installed, for example, near the hot showcase 1. The monitor 312 is an aspect of a notification device that provides a notification about the fried food X which needs to be disposed among the pieces of fried food X being displayed in the hot showcase 1.

Each of the controllers 311 having the hardware configuration described above is an information processing device that realizes, by an arithmetic function provided in the CPU 301, processing functions of the control programs stored in the ROM 303, the control programs and application programs loaded from a storage medium such as the HDD 304 into the RAM 302. The information processing described above is executed, thereby configuring a software control unit including various functional modules of each of the controllers 311. Combination of the software control unit configured as described above and hardware resources including the configurations as described above configures the functional blocks that realize the functions of each of the controllers 311.

The management server 321 also has a hardware configuration similar to that of each of the controllers 311. The control programs and application programs stored in a storage medium provided in each of the configurations are executed, thereby configuring the functional blocks that realize the functions of the management server 321.

The fried food disposal time management device 4 is configured to execute the specific information processing for managing the time to dispose the plurality of pieces of fried food X being displayed in the hot showcase 1. All the functions of the fried food disposal time management device 4 may be implemented in a store software provided in each of the controllers 311 or in a central management software provided in the management server 321, or the functions thereof may be distributed between the store software and the central management software and then implemented therein.

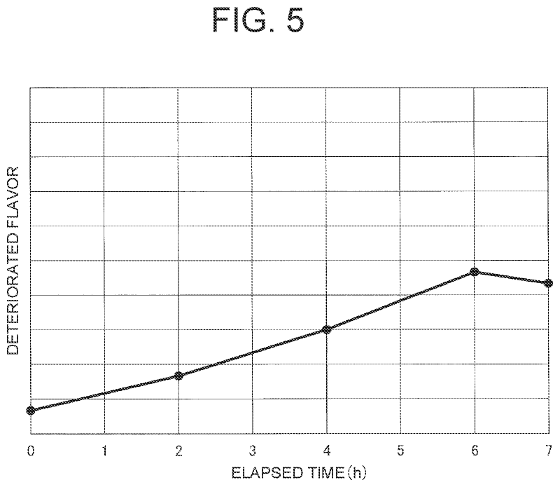

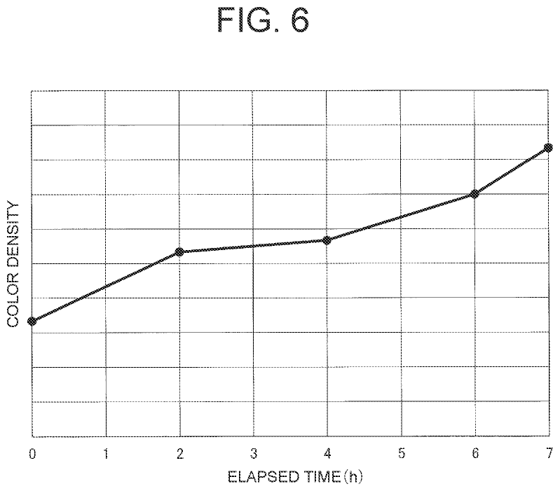

Here, the deterioration of flavor of the plurality of pieces of fried food X being displayed in the hot showcase 1 will be described with reference to FIG. 5 and FIG. 6.

FIG. 5 is a graph illustrating the change in the deteriorated flavor of fried foods obtained by sensory evaluation with respect to the elapsed time. FIG. 6 is a graph illustrating the change in the color density of fried foods obtained by sensory evaluation with respect to the elapsed time. In FIG. 6, the horizontal axis represents the elapsed time after the finishing of deep-frying of fried foods to be evaluated, and the vertical axis represents a value obtained by indexing the “color density” of the fried foods.

In FIG. 5, the horizontal axis represents the elapsed time after the finishing of deep-frying of fried foods to be evaluated, and the vertical axis represents the “deteriorated flavor”. The “deteriorated flavor” expresses how much the fried food is deteriorated, which is obtained by converting the flavor of the fried food into a predetermined evaluation point and using the accumulated value of the point. That is, if the value of the deteriorated flavor is low, it is estimated that the fried food is less deteriorated and a suitable condition has been maintained. On the other hand, if the value of the deteriorated flavor is high, it is estimated that the fried food has been deteriorated and thus the time to dispose the fried food is approaching. Thus, it is possible to determine whether the time to dispose the fried food is reached based on whether the deteriorated flavor exceeds a predetermined threshold value.

As illustrated in FIG. 5, in general, the more the time passes after the finishing of deep-frying of fried foods, the more the flavor thereof deteriorates (the level of deterioration of flavor increases). That is, based on FIG. 5, it can be considered that the flavor of fried foods decreases over time. It can be estimated that, among the plurality of pieces of fried food X being displayed in the hot showcase 1, the flavor of the one placed for a predetermined period of time after the finishing of deep-frying thereof deteriorates and is not suitable for sale to customers. Thus, when a predetermine time after the finishing of deep-frying of fried foods is reached, the fried food is subject to disposal.

As illustrated in FIG. 6, in the case of fried foods, the more the time passes after the finishing of deep-frying thereof, the more a value of the indicator indicating the color density of a fried food surface increases. That is, the color of the fried food surface tends to get darker over time. Here, a value of the “deteriorated flavor” illustrated in FIG. 5 also increases as the time passes after the finishing of deep-frying. Thus, there is a correlation between the color density of a fried food surface and the deterioration of flavor of a fried food.

In view of the above, in the present embodiment, the fried food disposal time management device 4 manages the time to dispose the plurality of pieces of fried food X, respectively, based on an indicator that changes in values in accordance with the decrease in the flavor of the fried food X in addition to the elapsed time from the finishing of deep-frying of the fried food X.

Here, an indicator used in the management of the time to dispose the fried food X is the one that has been confirmed to have a function to grasp the condition of the fried food X. For example, the indicator is, other than the color tone of the fried food X, the size, weight, water content, amount of volatile components, volatile component composition, acid value, anisidine value, carbonyl value, peroxide value, iodine value, and amount of polar compounds of the fried food X. In the following, an example of using the color tone of the fried food X as an indicator for the management of the time to dispose the fried food X will be described.

The fried food disposal time management device 4 identifies a surface image of each of the pieces of fried food X from the moving images or still images captured by the cameras 5, calculates RGB values of pixels which are components of the surface image, and analyzes the calculated RGB values as color components of each of the pieces of fried food X.

The method of analyzing the color of each of the pieces of fried food X does not necessarily have to be the method based on RGB values, and for example, it may be based on analysis of wavelengths such as HSV, HSB, HSL, Lab, and XYZ. In the case of using the moving images, extracting still images from the moving images at predetermined sampling times and using the still images as analysis targets enables analysis of the color components of each of the pieces of fried food X for each predetermined elapsed time.

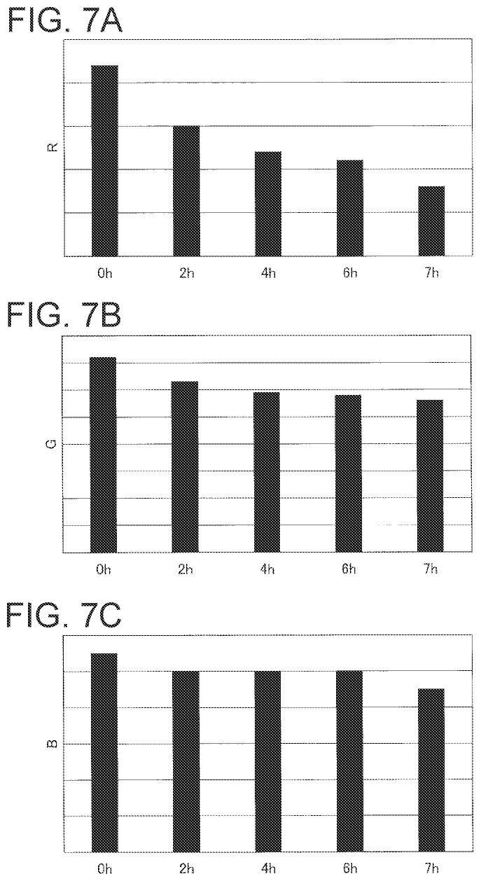

Next, an example of temporal trends of the “color density” of the fried food X experimentally confirmed by the Applicant, obtained by analyzing each color component (R, G, and B) using images similar to the images of the fried food X obtained by the cameras 5 will be described with reference to the graphs illustrated in FIG. 7 to FIG. 10.

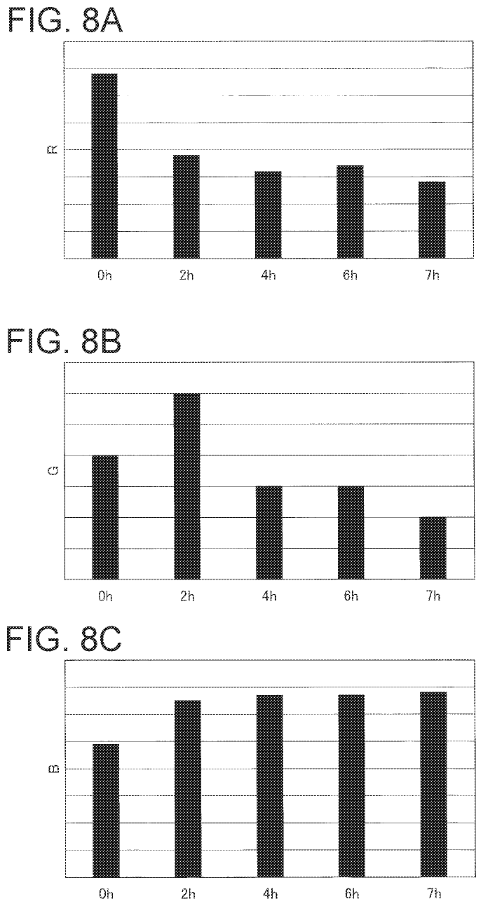

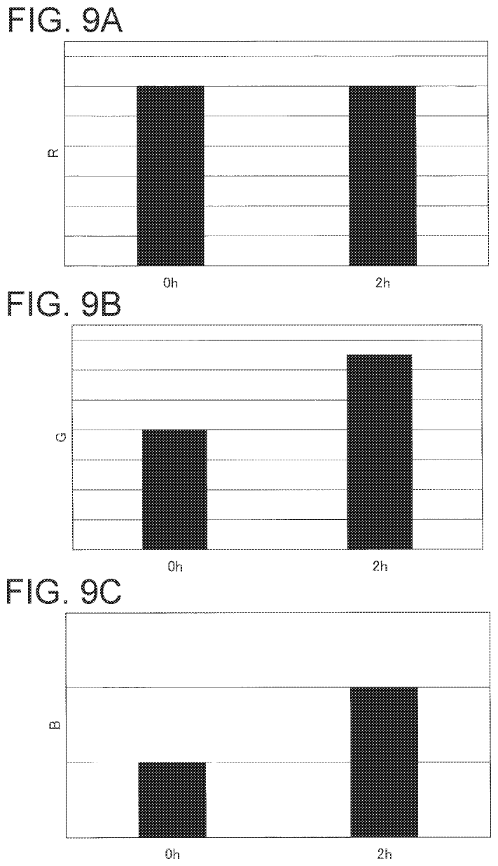

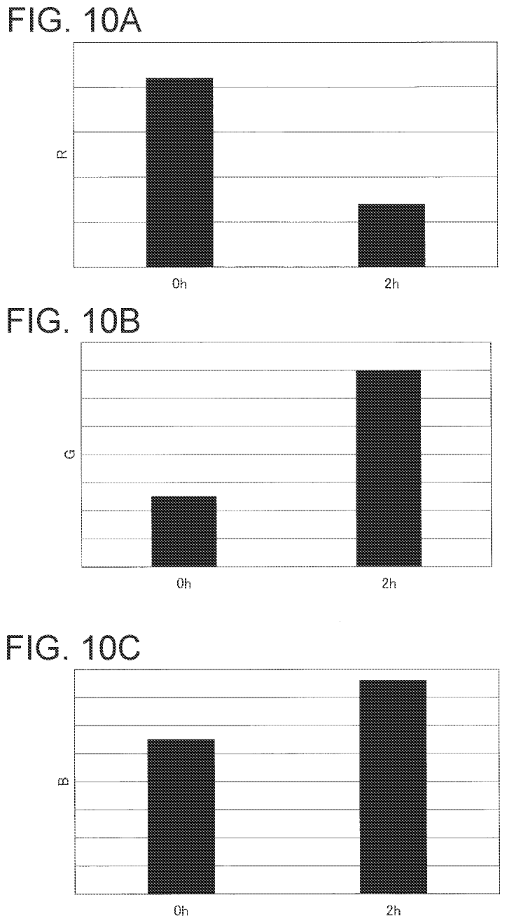

FIG. 7A, FIG. 8A, FIG. 9A, and FIG. 10A illustrate a trend of the component R with respect to the elapsed time, FIG. 7B, FIG. 8B, FIG. 9B, and FIG. 10B illustrate a trend of the component G with respect to the elapsed time, and FIG. 7C, FIG. 8C, FIG. 9C, and FIG. 10C illustrate a trend of the component B with respect to the elapsed time, respectively.

FIG. 7A to FIG. 7C are graphs illustrating the change in color components, which are obtained by capturing still images of a fried chicken being displayed in the hot showcase 1 and analyzing the captured still images, with respect to the elapsed time.

As illustrated in FIG. 7A to FIG. 7C, based on the analysis of the color components from the still images of the fried chicken being displayed in the hot showcase 1, it is found that all the components R, G, and B decrease after two hours (=2 h) from the finishing of deep-frying thereof (=0 h). As four hours, six hours, and then seven hours pass from the finishing of deep-frying, all the components R, G, and B tend to decrease as a whole.

FIG. 8A to FIG. 8C are graphs illustrating the change in color components, which are obtained by capturing moving images of the fried chicken being displayed in the hot showcase 1 and analyzing the captured moving images, with respect to the elapsed time.

As illustrated in FIG. 8A to FIG. 8C, based on the analysis of the color components from the moving images of the fried chicken being displayed in the hot showcase 1, it is found that the component R decreases after two hours (=2 h) from the finishing of deep-frying thereof (=0 h) while the components G and B increase.

In the same manner as the analysis of the color components from the still images of the fried chicken, it is found that the component R decreases as a whole as four hours, six hours, and then seven hours pass from the finishing of deep-frying. On the other hand, it is found that the component G obtained after four hours from the finishing of deep-frying decreases as compared with the content obtained immediately after the finishing of deep-frying thereof and that obtained after two hours from the finishing of deep-frying, and further decreases after seven hours from the finishing of deep-frying. Furthermore, the component B tends to slightly increase as a whole as the time passes from the finishing of deep-frying to four hours, six hours, and then seven hours.

FIG. 9A to FIG. 9C are graphs illustrating the change in color components, which are obtained by capturing still images of a croquette being displayed in the hot showcase 1 and analyzing the captured still images, with respect to the elapsed time.

As illustrated in FIG. 9A to FIG. 9C, based on the analysis of the color components from the still images of the croquette being displayed in the hot showcase 1, it is found that the component R does not change after two hours (=2 h) from the finishing of deep-frying thereof (=0 h) while the components G and B increase.

FIG. 10A to FIG. 10C are graphs illustrating the change in color components, which are obtained by capturing moving images of the croquette being displayed in the hot showcase 1 and analyzing the captured moving images, with respect to the elapsed time.

As illustrated in FIG. 10A to FIG. 10C, based on the analysis of the color components from the moving images of the croquette being displayed in the hot showcase 1, it is found that the component R decreases after two hours (=2 h) from the finishing of deep-frying thereof (=0 h) while the components G and B increase in the same manner as the analysis of the color components from the still images of the croquette.

In view of the above, for the fried food X being displayed in the hot showcase 1, based on the tendency of the change in the color tone with the elapsed time from the finishing of deep-frying thereof (particularly, in the case of fried chickens and croquettes, it appears remarkably after two hours from the finishing of deep-frying), a color component reference value (reference RGB values) for determining the time to dispose the fried food X can be set in advance.

Note that the color component reference value may be set to a predetermined value evenly to every piece of fried food X regardless of their type, or may be set to a different value for each type of the fried food X. For example, as illustrated in FIG. 8 and FIG. 10, based on the analysis of the color components from the moving images, the same tendency (R decreases but G and B increase) is found both in the fried chicken and the croquette after two hours passed, however, based on the analysis of the color components from the still images, the tendency which differs between the fried chicken and the croquette (in the case of the fried chicken, all of R, G, and B decrease while, in the case of the croquette, R does not change but G and B increase) is found.

Thus, in the case of analyzing the color components from the moving images, the color component reference value may be set to a predetermined value regardless of the type of the fried food X, however, in the case of analyzing the color components from the still images, setting the color component reference value to a different value for each type of the pieces of fried food X enables the fried food disposal time management device 4 to accurately determine the time to dispose.

### (Functional Structure of Fried Food Disposal Time Management System 4)

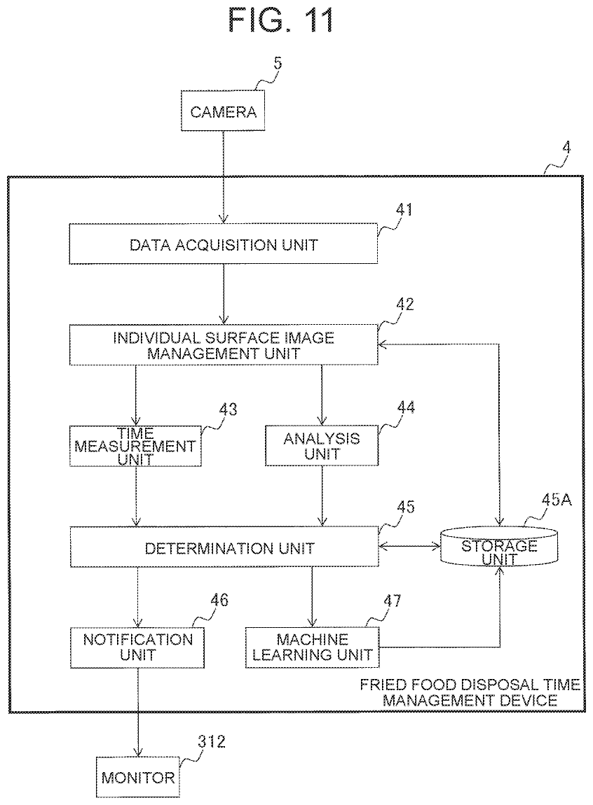

Next, the functional configuration of the fried food disposal time management device 4 will be described with reference to FIG. 11 to FIG. 13.

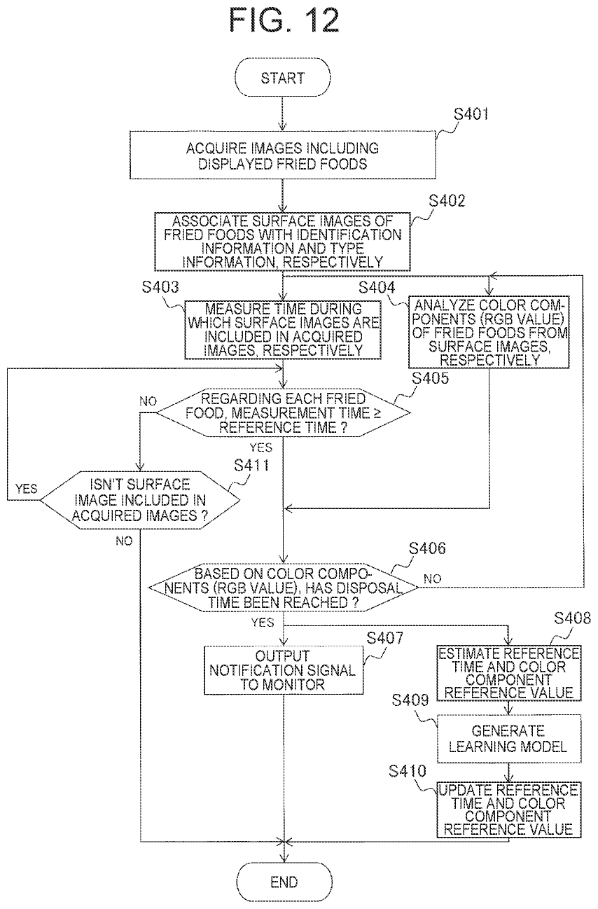

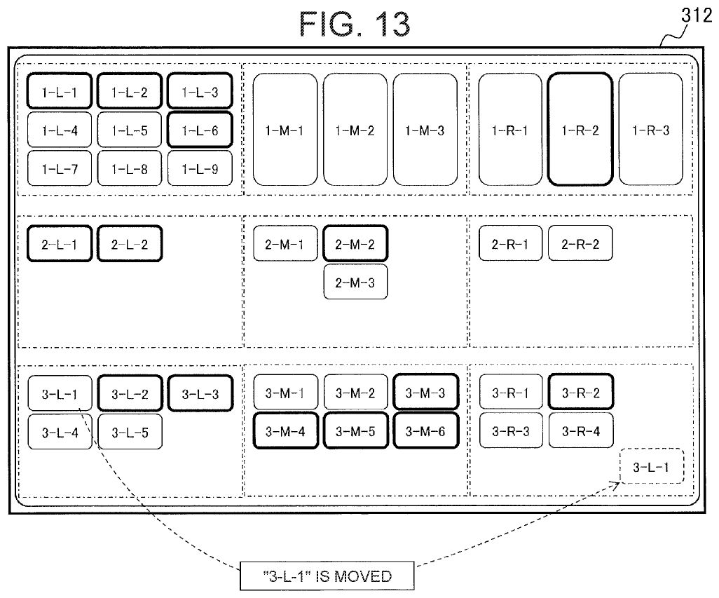

FIG. 11 is a functional block diagram illustrating the functions of the fried food disposal time management device 4. FIG. 12 is a flowchart illustrating a flow of processing executed by the fried food disposal time management device 4. FIG. 13 is a diagram illustrating a display example of the monitor 312.

The fried food disposal time management device 4 includes, for example, an image acquisition unit 41, an individual surface image management unit 42, a time measurement unit 43, an analysis unit 44, a determination unit 45, a storage unit 45A, a notification unit 46, and a learning unit 47.

The image acquisition unit 41 acquires images captured by each of the cameras 5, which include images of a plurality of pieces of fried food X for each of the floors 11, 12, 13.

The individual surface image management unit 42 generates identification information individually identifying a surface image of each of the pieces of fried food X, and manages the surface image of each of the pieces of fried food X included in the images acquired by the image acquisition unit 41 in association with the identification information. The generated identification information is stored in the storage unit 45A.

For example, executing the image processing for extracting the outline form of each of the pieces of fried food X included in the images captured by each of the cameras 5 to identify an image area of each of the pieces of fried food X enables acquisition of a surface image of each of the pieces of fried food X from the images acquired by the image acquisition unit 41.

In the present embodiment, the individual surface image management unit 42 manages the surface image of each of the pieces of fried food X in association with, in addition to the identification information, the type information identifying the type thereof. For identification of the type of each of the pieces of fried food X, the individual surface image management unit 42 compares the surface image with a sample image serving as a reference for identification. The sample images are stored in the storage unit 45A. Furthermore, for example, in the case where the monitor 312 has a function as an input terminal, the image management unit 42 can identify the type of each of the pieces of fried food X based on the type which has been manually input by an employee of the store through the monitor 312.

For example, regarding a croquette X1 being displayed on the third stage floor 13 in the hot showcase 1 illustrated in FIG. 1, the individual surface image management unit 42 extracts the surface image of the croquette X1 from the images captured by the camera 5 corresponding to the third stage floor 13, and manages the extracted surface image in association with the type information on “croquette” together with the identification information of “3-L-1”.

The method of generating the identification information is not particularly limited. For example, the identification information can be generated using “floor stage (first stage, second stage, third stage)—row (left, center, right)—position in each tray 2 (1, 2, 3 . . . )” which are the information immediately after the finishing of deep-frying. For example, the identification information “3-L-1” indicates the first piece of fried food X (croquette X1) which was placed on the tray 2 at the left end viewed from the rear side of the hot showcase 1 on the third stage floor 13 immediately after the finishing of deep-frying thereof (at the time when it was initially placed in the hot showcase 1).

Here, “the first piece of fried food X placed on the tray 2” means “the fried food X firstly placed” on the tray 2 when no piece of fried food X was placed thereon (when the tray 2 is empty). In this case, the third element of the identification information is the one indicating the cumulative number of pieces of fried food X placed on the tray 2 at the left end of the third stage floor 13. However, the identification information is only information individually identifying the pieces of fried food X being displayed in the hot showcase 1 at a certain point in time. Thus, the “first piece of fried food X” may be the one indicating the cumulative number thereof from the initial state of the hot showcase 1, or may be provided in a manner allowing each of the pieces of fried food X to be distinguished again after the initial state (zero) is restored at a certain point in time. As illustrated in the present embodiment, therefore, the number indicating the third element of the identification information is not necessarily a serial number, but may be provided randomly as long as it can be used for identification of each of the pieces of fried food X.

The time measurement unit 43 measures the elapsed time since the surface image associated with the identification information and type information by the individual surface image management unit 42 starts being included in the images acquired by the image acquisition unit 41. That is, the time measurement unit 43 keeps measuring the time while the fried food X remains in the hot showcase 1, starting from the time at which the fried food X which has been finished being deep-fried was placed in the hot showcase 1. When this fried food X is taken out from the hot showcase 1, the elapsed time related thereto is reset.

The analysis unit 44 analyzes color components (RGB values) from the surface image of each of the pieces of fried food X. Specifically, the analysis unit 44 identifies an analysis region composed of a predetermined group of pixels from the image region of each of the pieces of fried food X identified by the individual surface image management unit 42. Then, the analysis unit 44 acquires and analyzes the component R, component G, and component B of each of the pixels included in the analysis region as identified. Note that the analysis region does not have to be based on the size of the image region of each of the pieces of fried food X, but may be set by a predetermined number of pixels, or may be identified by the pixels sampled at a fixed ratio with respect to the number of pixels included in the image region.

The determination unit 45 determines whether the elapsed time of each of the pieces of fried food X measured by the time measurement unit 43 reaches a reference time predetermined as a reference for disposing each of the pieces of fried food X.

The “reference time” is stored in the storage unit 45A, and may be set to a specific time corresponding to the disposal time of the fried food X, or may set to a time enough until a specific time is reached (before a specific time). For example, the reference time may be set to a time which is ten minutes before the disposal time.

Furthermore, in the present embodiment, the “reference time” is set in association with the type information which is associated with the surface image by the individual surface image management unit 42. As described above, the reference time corresponds to a threshold value for individually determining whether the disposal time is reached for each of the pieces of fried food X. Depending on the type, the relationship between the elapsed time from the finishing of deep-frying of the fried food X and the decrease in flavor may differ. In view of the above, setting the reference time in association with the type information indicating the type of each of the pieces of fried food X enables improvement in the determination accuracy. Note that the reference time does not necessarily have to be set based on the type information, and may be set to a predetermined time regardless of the type of the fried food X.

Furthermore, in the present embodiment, the determination unit 45 further determines whether the time to dispose thereof is reached for each of the pieces of fried food X based on the color components of each of the pieces of fried food X analyzed by the analysis unit 44 and color components (color component reference value) predetermined as references for determining the time to dispose thereof.

The “color component reference value” is stored in the storage unit 45A, and may be set to a value (RGB value) based on the type information associated with the surface image by the individual surface-image management unit 42, or may be set to a predetermined value regardless of the type information.

Regarding the fried food X determined by the determination unit 45 that the elapsed time thereof has reached the reference time and also its disposal time has been reached based on the color components, the notification unit 46 outputs, to the monitor 312, a notification signal for notifying that this fried food X needs to be disposed. The notification unit 46 may be configured to output, in addition to the information notifying that the time to dispose is reached, the elapsed time and numerical values of the color components related to the determination that the fried food X should be disposed, as the determination result. The information (signal) output by the notification unit 46 is not limited to the specific type and expression or notification format as long as it is the information capable of prompting an employee of the store to dispose the fried food X as determined.

Based on the notification signal from the notification unit 46, the monitor 312 visualizes and presents the condition related to the disposal of the fried food X being displayed in the hot showcase 1. For example, as illustrated in FIG. 13, the monitor 312 shows a display structure (display structure of each of the floors 11, 12, 13 illustrated in FIG. 2) as viewed from the rear side of the hot showcase 1.

Specifically, the uppermost stage of the monitor 312 shows a display structure of the tray 2 on the left end side of the first stage floor 11, a display structure of the tray 2 on the center of the first stage floor 11, and a display structure of the tray 2 on the right end side of the first stage floor 11 at its left position, center position, and right position, respectively. Similarly, the middle stage of the monitor 312 shows a display structure of the tray 2 on the left end side of the second stage floor 12, a display structure of the tray 2 on the center of the second stage floor 12, and a display structure of the tray 2 at the right end side of the second stage floor 12 on its left position, center position, and right position, respectively. The lowermost stage of the monitor 312 shows a display structure of the tray 2 on the left end side of the third stage floor 13, a display structure of the tray 2 on the center of the third stage floor 13, and a display structure of the tray 2 on the right end side of the third stage floor 13 at its left position, center position, and right position, respectively. In FIG. 13, the boundaries between the trays 2 are indicated by dashed-dotted lines.

The monitor 312 shows a display state in the hot showcase 1 at the present time together with the identification information, and the displayed items are updated with the lapse of time. For example, the croquette X1 mentioned above (identification information; 3-L-1) was placed in the tray 2 on the left end side of the third stage floor 13 immediately after the finishing of deep-frying thereof (indicated by a solid line in FIG. 13) Thereafter, when the croquette X1 has been moved by an employee of the store into the tray 2 on the right end side of the third stage floor 13, on the monitor 312, the croquette X1 (identification information; 3-L-1) is displayed in the lower right tray 2 (indicated by a broken line in FIG. 13).

Based on the notification signal output from the notification unit 46, the pieces of fried food X which have been determined to be disposed by the determination unit 45 are displayed in such a manner that the numbers corresponding thereto (for example, identification information) blink or are displayed with different color on the monitor 312. The method of notifying the time to dispose the fried food X may include, not only visualizing the notification on the screen of the monitor 312 but also sounding a buzzer or the like. In FIG. 13, the numbers provided to the pieces of fried food X determined to be disposed are indicated by thick lines.

Furthermore, for example, in the case where the reference time used in the disposal time determination by the determination unit 45 is not set to the disposal time per se but is set to the time one hour before the disposal time, the monitor 312 may display a message such as “disposal time will be in one hour. Please move it to a lower temperature position” on the screen based on the notification signal output from the notification unit 46. Note that moving the fried food X near to disposal to a position whose temperature is lower than that of the current position within the hot showcase 1 keeps the taste thereof good longer.

In the present embodiment, the fried food disposal time management device 4 includes the learning unit 47 that generates a learning model capable of determining the time to dispose the fried food X by machine learning or regression analysis. The learning unit 47 estimates a reference time and color component reference value based on the determination result by the determination unit 45, performs the machine learning or regression analysis using the estimated reference time and color component reference value or the actually measured time and color component value to generate a learning model, and updates the reference time and color component reference value stored in the storage unit 45A based on the generated learning model. This improves the accuracy of determination result by the determination unit 45.

Specifically, the learning unit 47 generates a calibration line (model equation) using reference value data (explanatory variable) already stored in the storage unit 45A, for example, by linear regression, support vector machine (SVM), bugging, boosting, AdaBoost, decision tree, random forest, logistic regression, neural network, deep learning, in deep learning, especially a convolution neural network (CNN) and recurrent neural network (RNN), long short-term memory (LSTM), or the like.

As the type of linear regression (analysis), for example, single regression, multiple regression, partial least-squares (PLS) regression, and orthogonal projection partial least squares (OPLS: orthogonal partial least squares) regression have been known. At least one of these types can be selected and used.

Single regression is an approach for predicting one objective variable by one explanatory variable while multiple regression is an approach for predicting one objective variable by a plurality of explanatory variables. The (orthogonal projection) partial least squares regression is an approach for extracting principal components corresponding to small features (obtained by principal component analysis with explanatory variables only) so that the covariance between the principal components and the objective variable is maximized. The (orthogonal projection) partial least squares regression is a suitable approach when the number of explanatory variables is greater than the number of samples and the correlation among explanatory variables is strong.

Applying the calibration curve obtained by the machine learning or regression analysis in the learning unit 47 to the time measured by the time measurement unit 43 and the color components analyzed in the analysis unit 44 enables estimation of the determination reference value and supply of the result thereof to the determination unit 45.

The learning unit 47 may be configured to generate the learning model per user who creates and inputs the data. In this case, in the determination of the time to dispose the fried food X using a learning model, each user uses only the learning model generated based on the data provided by each user themselves. This enables determination of the time to dispose specifically to the environment in the hot showcase 1 of each user.

Furthermore, the learning unit 47 may be configured to generate the learning model without distinguishing units of users who create and input data. In this case, the learning model can be generated using a larger amount of data. When the generated learning model is used, the time to dispose the fried food X is determined using the characteristics (for example, type of the fried food X), which are predefined per user unit, and the color components as input data. This enables highly precise determination of time to dispose using a learning model with a larger amount of machine learning based on the environments in the hot showcases 1 of a plurality of users.

Still further, the learning unit 47 can generate not only a learning model capable of determining the time to dispose the fried food X but also a learning model capable of identifying the type of fried food X. This enables the individual surface image management unit 42 to make association of the type information on the fried food X more accurately.

As illustrated in FIG. 12, in the fried food disposal time management device 4, firstly, the image acquisition unit 41 acquires images (image including images of a plurality of pieces of fried food X being displayed in the hot showcase 1) captured by each of the cameras 5 in the image capturing step (step S401).

Next, the individual surface image management unit 42 generates identification information on the pieces of fried food X, respectively, extracts surface images of the pieces of fried food X from the images acquired in step S401, respectively, and manages the extracted surface images in association with the identification information and type information, respectively (step S402; individual surface image managing step).

Next, the time measurement unit 43 measures the time during which the surface images associated with the identification information and type information in step S402 are being included in the images acquired in step S401, respectively (step S403; time measuring step).

Meanwhile, the analysis unit 44 analyzes the color components (RGB value) the pieces of fried food X from the surface images associated with the identification information and type information in step S402, respectively (step S404; analyzing step).

Next, the determination unit 45 determines, for each of the pieces of fried food X, whether the time measured in step S403 reaches the reference time (step S405; determining step). Regarding the fried food X whose measured time is determined to have reached the reference time (measurement time≥reference time) in step S405 (step S405/YES), the determination unit 45 subsequently determines whether the time to dispose the fried food X has been reached based on the color components analyzed in step S404 (step S406; determining step).

Regarding the fried food X whose disposal time is determined to have been reached in step S406 (step S406/YES), the notification unit 46 outputs a notification signal for notifying that the disposal time is reached to the monitor 312 (step S407). Upon receiving the notification signal, the monitor 312 notifies that the fried food X whose disposal time has been reached needs to be disposed (notifying step). On the other hand, regarding the other pieces of fried food X whose disposal time is not determined to have been reached in step S406 (step S406/NO), the flow returns to step S404 and then the processing is repeated.

In the present embodiment, regarding the fried food X whose disposal time is determined to have been reached in step S406 (step S406/YES), the learning unit 47 estimates the reference time and color component reference value based on the determination result (step S408). Subsequently, the learning unit 47 performs machine learning or regression analysis using the reference time and color component reference value estimated in step S408 so as to generate a learning model (step S409). Note that, in step S409, the learning unit 47 does not necessarily have to use the reference time and color component reference value estimated in step S408, and for example, may be configured to generate a learning model using the actually measured time and color component value.

Then, the learning unit 47 updates the reference time and color component reference value stored in the storage unit 45A based on the learning model generated in step S409 (step S410). After the processes in step S407 and step S410 are executed, the processing by the fried food disposal time management device 4 is ended.

Regarding each of the other pieces of fried food X whose measured time is not determined to have reached the reference time (measurement time<reference time) in step S405 (step S405/NO), it is determined whether the surface image thereof is being included in the images acquired in step S401 (step S411).

When it is determined in step S411 that a surface image of the relevant fried food X is not being included in the images captured by the camera 5 (step S411/NO), the processing by the fried food disposal time management device 4 is ended. On the other hand, when it is determined in step S411 that the surface image of the relevant fried food X is being included in the images captured by the camera 5 (step S411/YES), the flow returns to step S405 and then the processing is repeated.

As described above, continuously or intermittently capturing images of a plurality of pieces of fried food X being displayed in the hot showcase 1 by means of the cameras 5 and identifying each of the pieces of fried food X based on the captured images enables accurate determination of the time to dispose each of the pieces of fried food X even when it was moved in the hot showcase 1. This enables reduction in the burden on an employee of a store who has been required to manually keep records, and easy management of the disposal time of the plurality of pieces of fried food X in the hot showcase 1 can be realized.

In the fried food disposal time management device 4 according to the present embodiment, the determination unit 45 determines whether the time to dispose the fried food X has been reached based on the color components of the fried food X in addition to the elapsed time from the finishing of deep-frying thereof. However, the determination unit 45 can be configured to determine whether the time to dispose the fried food X has been reached based on at least the elapsed time from the finishing of deep-frying thereof. That is, regarding the fried food X whose measured time has reached the reference time in step S405 illustrated in FIG. 12 (step S405/YES), a notification signal may be output to the monitor 312 (step S407) while the processes in step S404 and step S406 (determination based on the color components of the fried food X) are skipped. Furthermore, instead of using color components, the size of the fried food X may be used in the determination of the disposal time. It is commonly known that the size of the fried food decreases as time passes from the finishing of deep-frying thereof.

### (Modification)

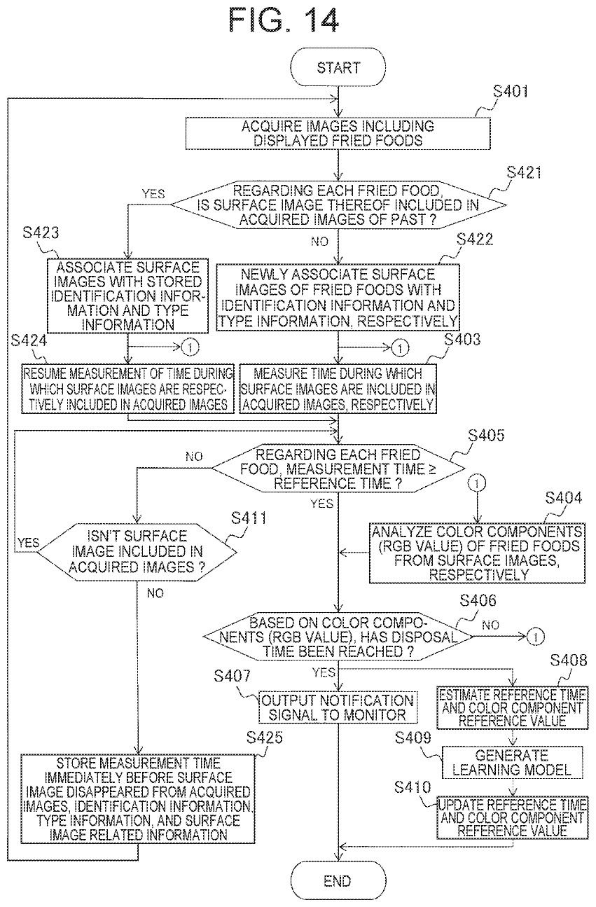

Next, a fried food disposal time management device 4A according to a modification of the present invention will be described with reference to FIG. 14. In FIG. 14, components common to those described with respect to the fried food disposal time management device 4 according to the embodiment described above are provided with the same reference signs, and explanation therefor will be omitted.

FIG. 14 is a flowchart illustrating a flow of processing executed by the fried food disposal time management device 4A according to the modification of the present invention.

In the present modification, the fried food disposal time management device 4A includes the process in the case where the fried food X has been once removed from the hot showcase 1 and then returned to the hot showcase 1.

Firstly, the fried food disposal time management device 4A acquires images including images of a plurality of pieces of fried food X being displayed in the hot showcase 1, and extracts surface images of the pieces of fried food X, respectively (step S401). Subsequently, based on surface image related information stored in the storage unit 45A, the fried food disposal time management device 4A determines whether the surface image of each of the pieces of fried food X extracted in the currently executing processing is the one which has already been stored in the storage unit 45A, that is, whether the extracted surface image is included in the image acquired in step S401 of the past (hereinafter, simply referred to as “acquired image”) (step S421).

Here, the “surface image related information” is information that can be acquired from the surface image of each of the pieces of fried food X extracted from the images captured by each of the cameras 5, and specifically, includes the information on the color tone (color components), size, and shape of each of the pieces of fried food X. The “surface image related information” may include the surface image per se, or may include information structuring the information on, for example, feature points included in the surface image. In any case, the “surface image related information” is sufficient as long as it is information group enabling determination as to whether, regarding the fried food X included in the image acquired in step S401 (acquired image), its elapsed time was measured in the past.

When determining in step S421 that the surface image as a target of the determination is not the one associated with the surface image related information stored in the storage unit 45A (step S421/NO), the fried food disposal time management device 4A newly associates the target surface image with the identification information and type information (step S422). Here, in the case of having extracted a plurality of surface images which are targets of the determination in step S421, the fried food disposal time management device 4A makes determination of S421 for each of the plurality of surface images. Then, in the same manner as the embodiment described above, the flow proceeds to step S403 and step S404.

On the other hand, when the surface image which is a target of the determination in step S421 is the one associated with the surface image related information stored in the storage unit 45A, that is, when the target surface image is the surface image of the fried food X determined to be included in the acquired image which does not relate to S401 executed immediately before the determination processing but relates to S401 executed further in the past (step S421/YES), the fried food disposal time management device 4A associates the surface image with, together with the identification information and type information stored in the storage unit 45A, the measurement time associated with the surface image related information that was determined to be associated with the surface image (step S423).

Next, the time measurement unit 43 resumes, starting from the measurement time associated with the surface image in step S423, measurement of time during which the surface image is being included in the acquired image (step S424). Then, in the same manner as the embodiment described above, the flow proceeds to step S405. Note that the fried food disposal time management device 4A executes the process in step S404 in parallel with the process in step S424.

Regarding the fried food X determined in step S405 that its measurement time has not reached the reference time (step S405/NO) and then determined in step S411 that no surface image thereof is included in the acquired image (step S411/NO), the fried food disposal time management device 4A stores the measurement time until the timing at which the surface image related to the fried food X is determined not to be included in the acquired image, that is, the timing at which “NO” is determined in step S411, and the identification information, type information, and surface image related information which have been provided to the surface image related to the fried food X (step S425). Then, the flow returns to step S401.

That is, all of the surface image related information used in step S421, the identification information and type information used in step S423, and the measurement time immediately before the surface image used in step S424 disappeared from the acquisition screen are the information stored in the storage unit 45A in step S425.

As described above, the fried food disposal time management device 4A includes the process in the case where the fried food X has been once taken out from the hot showcase 1 and returned to the hot showcase 1, thereby realizing the management of the disposal time of a plurality of pieces of fried food X being displayed in the hot showcase 1 with higher accuracy. In the present modification, similarly to the embodiment described above, regarding the fried food X whose measurement time has reached the reference time in step S405 (step S405/YES), the fried food disposal time management device 4A may skip the processes of step S404 and step S406 and output a notification signal for notifying that it is time for disposing the fried food X to the monitor 312 (step S407).

In the present modification, the fried food disposal time management device 4A automatically performs the processing in the case where the fried food X has been once taken out from the hot showcase 1 and returned to the hot showcase 1, but the present invention is not limited thereto. For example, the processing can be realized in such a manner, when the fried food X was taken out from the hot showcase 1, an employee of the store manually inputs the identification information on the fried food X to the monitor 312 or the like so that the fried food disposal time management device 4A uses the input identification information to determine whether the fried food X is a new one.

In the above, the present invention has been described with reference to the embodiment of the present invention. The present invention is not limited to the embodiment described above, but include various modifications. For example, the embodiment is described in detail herein for clarity, and the present invention is not necessarily limited to those including all the features described above. Furthermore, some of the features according to a predetermined embodiment can be replaced with other features according to the separate embodiments, and other features can be added to the configuration of a predetermined embodiment. Still further, some of the features can include other features of the separate embodiments, be deleted, and/or replaced.

For example, in the embodiment described above, as an aspect of a display cabinet in which a plurality of pieces of fried food X is displayed, the hot showcase 1 provided with the three floors 11, 12, 13 has been described. However, the display cabinet does not necessarily have to include a plurality of floors, and for example, a tray or the like may be included. The aspect of the display cabinet is not limited as long as the fried food X can be displayed therein.

Furthermore, in the embodiment described above, as the food disposal time management device, the fried food disposal time management device 4 for managing the time to dispose a plurality fried foods being displayed in a hot showcase has been described, however the present invention is not limited thereto. For example, the food disposal time management device according to the present invention may be a steamed food disposal time management device for managing a plurality of Chinese buns displayed in a steamer.

### REFERENCE SIGNS LIST

1: hot showcase (display cabinet)
3: fried food disposal time management system (food disposal time management system)
4, 4A: fried food disposal time management device (food disposal time management system)
5: camera (image capturing device)
41: image acquisition unit
42: individual surface image management unit
43: time measurement unit
44: analysis unit
45: determination unit
46: notification unit
47: learning unit
312: monitor (notification device)
X: fried food (food)

1. A food disposal time management device for managing a disposal time of a cooked food displayed in a display cabinet, comprising:
an image acquisition unit that acquires an image including images of a plurality of foods being displayed in the display cabinet;
an individual surface image management unit that generates identification information individually identifying a surface image of each of the foods, and manages the surface image included in the image acquired by the image acquisition unit in association with the identification information;
a time measurement unit that measures a time during which the surface image associated with the identification information by the individual surface image management unit is being included in the image;
a determination unit that determines, for each of the plurality of foods, whether the time measured by the time measurement unit has reached a reference time predetermined as a reference of an elapsed time used in food disposal; and
a notification unit that outputs, to a notification device, a notification signal for notifying that a food whose time as measured is determined to have reached the reference time by the determination unit needs to be disposed.

2. The food disposal time management device according to claim 1, wherein
the individual surface image management unit manages the surface image in association with type information identifying type of food in addition to the identification information, and
the determination unit determines, for each of the plurality of foods, whether the time measured by the time measurement unit has reached the reference time which is based on the type information associated with the surface image by the individual surface image management unit.

3. The food disposal time management device according to claim 1, further comprising a learning unit that generates a learning model capable of determining a disposal time of a food by machine learning or regression analysis, wherein
the learning unit estimates the reference time based on a determination result by the determination unit, performs the machine learning or regression analysis using the reference time as estimated so as to generate the learning model, and updates the reference time based on the learning model as generated.

4. The food disposal time management device according to claim 1, further comprising an analysis unit that analyzes color components or size of a food in the surface image associated with the identification information by the individual surface image management unit, wherein
the determination unit determines whether, for each of the plurality of foods, the disposal time thereof has been reached based on the color components or the size analyzed by the analysis unit and color components or size predetermined as a reference for determining a disposal time of a food.

5. A food disposal time management system for managing a disposal time of a food displayed in a display cabinet, comprising:
an image capturing device that captures an image including images of a plurality of foods being displayed in the display cabinet;
a food disposal time management device that manages a disposal time of each of the plurality of foods being displayed in the display cabinet; and
a notification device that notifies that a food whose disposal time is determined to have been reached by the food disposal time management device needs to be disposed,
the food disposal time management device being configured to:
acquire the image output from the image capturing device;
generate identification information individually identifying a surface image of each of the plurality of foods and manage the surface image included in the image as acquired in association with the identification information;
measure a time during which the surface image associated with the identification information is being included in the image;
for each of the plurality of foods, determine whether the time as measured reaches a reference time predetermined as a reference of an elapsed time used in food disposal; and output, to the notification device, a notification signal for notifying that a food whose measured time is determined to have reached the reference time needs to be disposed.

6. The food disposal time management system according to claim 5, wherein
the food disposal time management device is configured to:
manage the surface image in association with type information identifying type of food in addition to the identification information, and
determine, for each of the plurality of foods, whether the time as measured has reached the reference time which is based on the type information associated with the surface image.

7. The food disposal time management system according to claim 5, wherein
the food disposal time management device is configured to:
analyze color components or size in the surface image associated with the identification information; and
determine whether, for each of the plurality of foods, the disposal time thereof has been reached based on the color components or the size as analyzed and predetermined color components or size predetermined as a reference for determining a disposal time of a food.

8. A food disposal time management method for managing a disposal time of a food displayed in a display cabinet, comprising the steps of:
as an image capturing step, capturing an image including images of a plurality of foods being displayed in the display cabinet;
as an individual surface image management step, generating identification information individually identifying a surface image of each of the plurality of foods and managing the surface image included in the image captured in the image capturing step in association with the identification information;
as a time measuring step, measuring a time during which the surface image associated with the identification information in the individual surface image managing step is being included in the image;
as a determining step, determining whether, for each of the plurality of foods, the time measured in the time measuring step reaches a reference time predetermined as a reference of an elapsed time used in food disposal; and
as a notifying step, notifying that the food whose measured time is determined to have reached the reference time in the determining step needs to be disposed.

9. The food disposal time management method according to claim 8, wherein
the individual surface image managing step further includes managing the surface image in association with type information identifying type of food in addition to the identification information, and
the determining step further includes determining, for each of the plurality of foods, whether the time measured in the time measuring step reaches the reference time which is based on the type information associated with the surface image in the individual surface image managing step.

10. The food disposal time management method according to claim 8, further comprising, as an analyzing step, analyzing color components or size in the surface image associated with the identification information in the individual surface image managing step, wherein
the determining step further includes determining whether, for each of the plurality of foods, the disposal time thereof has been reached based on the color components or the size analyzed in the analyzing step and color components or size predetermined as a reference for determining a disposal time of a food.
